(19) United States
(12) Patent Application Publication
(10) Pub. No.: US 2006/0117799 A1
(43) Pub. Date: Jun. 8, 2006

(54) Method for coating doughnut-type glass substrates

(75) Inventors: Osamu Miyahara, Yokohama-shi (JP); Masami Kaneko, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Asahi Glass Company, Limited, Chiyoda-ku (JP)

(21) Appl. No.: 11/271,787

(22) Filed: Nov. 14, 2005

(30) Foreign Application Priority Data
Dec. 6, 2004 (JP) 2004-353008

(51) Int. Cl. G11B 5/016; C03B 18/00; G11B 17/08; B32B 3/02

(52) U.S. Cl. 65/404; 428/66.4; 360/98.08; 360/99.05

(57) ABSTRACT

A method for coating doughnut-type glass substrates, which comprises laminating a plurality of doughnut-type glass substrates each having a circular hole at its center so that the circular holes form a cylindrical hole, and supplying a coating liquid to an inner peripheral surface of the cylindrical hole in a state where the glass substrates are laminated to coat inner peripheral edge surfaces of the plurality of the doughnut-type glass substrates with the coating liquid.

The present invention relates to a method for coating inner peripheral edge surfaces of doughnut-type glass substrate for magnetic disks.

As a substrate for magnetic disks to be used for e.g. magnetic disk memory devices, an aluminum alloy substrate has been mainly employed. However, along with the demand for high density recording, a glass substrate has now been employed which is excellent in flatness and smoothness and of which the base material itself is hard as compared with an aluminum alloy substrate. However, a glass substrate for magnetic disks, made of glass which is a brittle material, is likely to break during handling or during use, which is regarded as one of the problems.

One of factors governing the mechanical strength of a doughnut-type glass substrate for magnetic disks, is scars which are present on the inner peripheral edge surface of the glass substrate where the maximum tensile stress will be exerted by high speed rotation during use of the magnetic disks. In a glass substrate for magnetic disks, it is common that the surface roughness of the inner peripheral edge surface and the outer peripheral edge surface (hereinafter sometimes generally referred to as the inner and outer peripheral edge surfaces) is coarse as compared with the main surface (the surface other than the inner and outer peripheral edge surfaces) required to have very high levels of flatness and smoothness. Namely, for example, when a doughnut-type glass substrate is cut out from a rectangular glass substrate, the inner and outer peripheral edge surfaces are cut surfaces formed by cutting or coring the disk out of the glass plate into a doughnut shape, and they are not concerned with the magnetic recording. Besides, they are curved surfaces, which require a high cost for finish processing, whereby finish processing can not adequately be carried out.

In order to reduce the depth of scars on the inner and outer peripheral edge surfaces and thereby to improve the mechanical strength, finish processing of the inner and outer peripheral edge surfaces is carried out with abrasive grains finer than #500 mesh, but considerably deep scars may still remain on the inner and outer peripheral edge surfaces. In order to improve the finishing of the inner and outer peripheral edge surfaces, that is, in order to decrease the roughness, multi-step processing by means of abrasive grains having stepwise reduced grain sizes is effective. However, such multi-step processing has a problem that productivity will thereby be substantially deteriorated, and the cost remarkably increases.

As a glass substrate to solve the above mentioned problems, JP-A-2-301017 discloses a glass substrate for magnetic disks, wherein a continuous layer of an oxide or a continuous layer composed mainly of an oxide having a thickness of from 0.2 to 50 μm, is formed on the inner peripheral edge surface or on the inner peripheral edge surface and the surface portion along the inner periphery.

Further, JP-A-2-301017 discloses use of a so-called wet process wherein process is carried out in the form of a solution or a slurry, followed by drying and heat treatment to obtain a cured film, for the formation of the continuous layer. Further, as a specific coating method to form a coating film on a limited portion such as an inner peripheral edge surface, it is disclosed that portions other than the inner peripheral edge surface is masked, and then dip coating, spin coating or roll coating is carried out.

Further, JP-A-11-328665 discloses a doughnut-type glass substrate for magnetic disks produced in such a manner that a coating composition containing a polysilazane is applied and cured on the etching-treated inner peripheral edge surface, or inner and outer peripheral edge surfaces of a doughnut-type glass substrate to form a protective film, and as a coating method, the following methods are exemplified.

A brush coating method wherein coating is carried out by means of a brush.

A roller coating method wherein a coating liquid is supplied to a porous surface of a roller brush, and the roller is rotated so that it is in contact with the surface to transfer and apply the coating liquid.

A direct coating method wherein the doughnut-type glass substrate is rotated at a rotational speed at from 10 to 200 rpm, and a coating liquid is supplied from a dispenser and applied.

As mentioned above, various methods have been known as a method of applying a coating liquid, to apply the coating liquid on the inner peripheral edge surface of a doughnut-type glass substrate to form a coating film, thereby to improve technical strength of the glass substrate. However, in each method, the coating liquid is applied on the inner peripheral edge surface of one glass substrate at a time, and in addition, as disclosed in JP-A-11-328665, portions other than the inner peripheral edge surface of the glass substrate have to be masked. Thus, such a method is poor in efficiency of the coating operation, is unsuitable for mass production, and leads an increase in cost. On the other hand, no method has been known to coat inner peripheral edge surfaces of a plurality of glass substrates all at once without masking portions other than the inner peripheral edge surfaces.

Under these circumstances, it is an object of the present invention to solve the above problems, and to provide a method of efficiently coating a large number of glass substrates with a coating liquid all at once, when a coating liquid is applied on inner peripheral edge surfaces of doughnut-type glass substrates to form a coating film.

To achieve the above object, the present inventors have conducted extensive studies on a method for efficiently applying a coating liquid on inner peripheral edge surfaces of doughnut-type glass substrates and as a result, found that inner peripheral edge surfaces of a large number of glass substrates can be coated with a coating liquid all at once without a masking treatment, by laminating a plurality of doughnut-type glass substrates and applying a coating liquid on inner peripheral edge surfaces in such a laminated state. The present invention has been accomplished on the basis of this discovery. Namely, the present invention provides the following method for coating doughnut-type glass substrates.

(1) A method for coating doughnut-type glass substrates, which comprises laminating a plurality of doughnut-type glass substrates each having a circular hole at its center so that the circular holes form a cylindrical hole, and supplying a coating liquid to an inner peripheral surface of the cylindrical hole in a state where the glass substrates are laminated to coat inner peripheral edge surfaces of the plurality of the doughnut-type glass substrates with the coating liquid.

(2) The method for coating doughnut-type glass substrates according to the above (1), wherein the coating liquid is applied while rotating the doughnut-type glass substrates.

(3) The method for coating doughnut-type glass substrates according to the above (1) or (2), wherein the coating liquid is applied by any one of a direct coating method of applying the coating liquid by means of a dispenser, a brush coating method or a roller coating method.

According to the present invention, a plurality of doughnut-type glass substrates are laminated so that their circular holes at their center form a cylindrical hole, and a coating liquid is applied on an inner surface of the cylindrical hole in such a state. Accordingly, the coating liquid can be applied only on the inner peripheral edge surfaces of the doughnut-type glass substrates without masking portions other than the inner peripheral edge surfaces, and in addition, as the coating liquid can be applied on the inner peripheral edge surfaces of the laminated doughnut-type glass substrates at a time, the coating liquid can be applied on the inner peripheral edge surfaces of a large number of glass substrates all at once.

In the accompanying drawing:

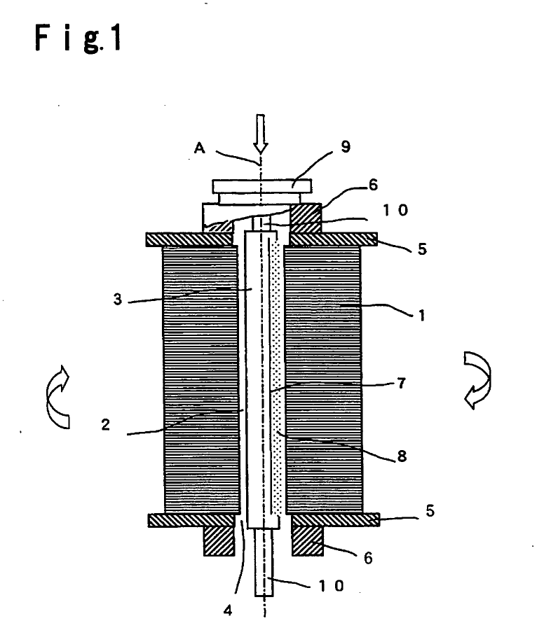

FIG. 1 is a cross-sectional view schematically illustrating a preferred embodiment of the coating method of the present invention.

Now, the present invention will be described in detail with reference to the preferred embodiments.

The doughnut-type glass substrate of the present invention is a doughnut-type glass substrate having a circular disk shape with a predetermined radius and having a circular cut hole having substantially the same center as the center of the disk at a center portion of is the disk, and having an inner peripheral edge surface, an outer peripheral edge surface and front and back main surfaces. In the following description, the glass substrate means such a doughnut-type glass substrate.

The dimensions of the doughnut-type glass substrates are not particularly limited, and the dimensions as represented by mm may, for example, be such that (a) inner diameter 7.0, outer diameter 21.4, plate thickness 0.38, (b) inner diameter 12.0, outer diameter 48.0, plate thickness 0.55, (c) inner diameter 25.0, outer diameter 84.0, plate thickness 1.0, (d) inner diameter 12.0, outer diameter 48.0, plate thickness 0.5, or (e) inner diameter 25.0, outer diameter 95.0, plate thickness 0.8.

The type of glass to be used for the doughnut-type glass substrates of the present invention is preferably a glass having the following characteristics, for the improvement of the weather resistance. However, the glass is not limited thereto.

Water resistance: When the glass is immersed in water of 80° C. for 24 hours, the weight reduction of the glass (eluted amount) due to elution of components from the glass, is not more than 0.02 mg/cm².

Acid resistance: When the glass is immersed in a 0.1 N hydrochloric acid aqueous solution of 80° C. for 24 hours, the weight reduction of the glass (eluted amount) due to elution of components from the glass, is not more than 0.06 mg/cm².

Alkali resistance: When the glass is immersed in a 0.1 N sodium hydroxide aqueous solution of 80° C. for 24 hours, the weight reduction of the glass (eluted amount) due to elution of components from the glass is not more than 1 mg/cm², more preferably not more than 0.18 mg/cm².

In the present invention, it is not required to use a chemical reinforcing method, and there is no lower limit in the content of an alkali metal such as Na or Li as the composition of the glass with a view to making chemical reinforcement possible. The glass which may be used for the doughnut-type glass substrates of the present invention, may, for example, be a glass having an alkali metal oxide content of from 1 to 20 mass %, such as soda lime silica glass, alumina silicate glass, alkali-free glass or crystallized glass.

In the present invention, as a coating liquid to be applied on the inner peripheral edge surfaces of the doughnut-type glass substrates, a solution, a dispersion liquid or the like which can be applied by wet process may be used. Specifically, a solution containing a silicone resin, a polyimide or a polysilazane, or a solution containing a metal alkoxide may, for example, be mentioned. Among them, a silicone resin, a polysilazane or a polyimide is suitable from such a viewpoint that a coating film to be formed will be excellent in weather resistance and corrosion resistance and will hardly be stained. However, the coating liquid is not limited thereto, and known materials for formation of a protective film of a glass substrate can widely be used.

The present invention is characterized in that, as mentioned above, a plurality of doughnut-type glass substrates are laminated so that their circular holes at their center form a cylindrical hole, and a coating liquid is supplied to an inner surface of the cylindrical hole in such a state to apply the coating liquid on the inner peripheral edge surfaces of the glass substrates. That is, when a plurality of doughnut-type glass substrates are laminated so that their circular holes at their center are at the same position, a through-hole having a circular cross-section i.e. a cylindrical hole is formed by inner peripheral edge surfaces of the glass substrates at the center portion of the laminated glass substrates. A coating liquid is supplied to an inner surface of the cylindrical hole in such a state to coat the inner peripheral edge surfaces of the plurality of the laminated glass substrates all at once. As the front and back surfaces of the laminated glass substrates are tightly contacted with the front and back surfaces of the adjacent glass substrates and shielded, the inner peripheral edge surfaces alone of the glass substrates are exposed as the inner surface of the cylindrical hole. Accordingly, by applying the coating liquid on the inner surface of the cylindrical hole, the inner peripheral edge surfaces alone of the glass substrates can be coated. On that occasion, as the coating liquid is not applied on portions other than the inner peripheral edge surfaces, no masking treatment on the portions other than the inner peripheral edge surfaces will be required.

In the present invention, the number of glass substrates to be laminated is not limited. In the present invention, the inner peripheral edge surfaces of laminated glass substrates are coated all at once, and accordingly, as the number of substrates laminated increases, a coating treatment on the inner peripheral edge surfaces of a large number of glass substrates can be carried out all at once. The number of glass substrates to be laminated depends on the thickness and is not limited, and in a case where thickness is from 0.35 to 1 mm, the number is appropriately from about 20 to about 250, in view of uniform coating of the inner surface of the cylindrical hole with the coating liquid, productivity, easiness (workability) of the coating operation, operation efficiency, etc.

In the present invention, the coating treatment on the inner peripheral edge surfaces of the laminated glass substrates i.e. the inner surface of the cylindrical hole may be carried out by various wet coating methods. Specifically, the following methods may be mentioned as typical examples.

(1) A brush coating method wherein coating is carried out by means of a brush.

(2) A roller coating method wherein a coating liquid is supplied to a porous surface of a roller brush made of e.g. a foamed plastic, and the roller of the roller brush is rotated at a rotational speed of from 10 to 60 rpm, so that it is brought in contact with the inner peripheral edge surfaces of the laminated glass substrates to transfer and apply the coating liquid.

(3) A direct coating method wherein the laminated glass substrates are rotated at a rotational speed of from 10 to 200 rpm, and a predetermined amount of a coating liquid is supplied from a dispenser and applied on the inner peripheral edge surfaces.

Further, various methods such as a method of discharging a coating liquid or a method of spraying a coating liquid may be applicable.

In the present invention, to coat the inner surface of the cylindrical hole, it is carried out preferably while rotating the laminated glass substrates at a constant rate upon the center axis of the cylindrical hole. By rotating the glass substrates, repeated application of the coating liquid will easily be carried out, and coating in a uniform thickness will be achieved.

In the present invention, the inner peripheral edge surfaces of the glass substrates on which the coating liquid is to be applied are preferably preliminarily ground by abrasive grains of from #200 to #1,000 mesh. It is more preferred to further apply an etching treatment to the ground surface. By grinding or further etching the inner peripheral edge surfaces, formation of a coating film with a uniform thickness will be accelerated, and particularly when the ground surface is etched, scars present on the ground surface can be removed, whereby strength of the glass substrate will further increase. Further, as the case requires, chamfering may be applied to the inner peripheral edge surfaces of the doughnut-type glass substrates.

Now, the preferred embodiment of the present invention will be explained with reference to FIG. 1, but the present invention is not limited thereto. FIG. 1 is a cross-sectional view schematically illustrating the coating method of the present invention. As shown in FIG. 1, a plurality of doughnut-type glass substrates 1 each having a circular hole at its center are laminated so that their circular holes form a cylindrical hole 2, a slit tube 3 is inserted in the cylindrical hole, and a coating liquid 8 is supplied from a slit 7 of the slit tube 3 to the inner surface of the cylindrical hole 2 to coat the inner peripheral edge surfaces of the laminated glass substrates.

The inner peripheral edge surface and the outer peripheral edge surface of each of the above glass substrates 1 are ground and processed into concentric circles having predetermined inner diameter and outer diameter, respectively, and they have predetermined surface roughness (Ra). Further, the front and back surfaces of each glass substrate 1 are processed to have desired flatness and smoothness. Several glass substrates 1 prepared in such a manner to be subjected to a coating treatment at a time are laminated so that they are arranged on the basis of the outer peripheral edge surfaces, for example, and they are sandwiched between presser plates 5 from both sides and fixed by fixtures 6 so that they will not slip. As the respective glass substrates 1 have the same outer diameter and the same inner diameter, the circular holes of the laminated glass substrates 1 are continuously arranged so that their centers are at the same position to form a cylindrical hole 2 as shown in FIG. 1. In FIG. 1, A illustrates a center axis of the cylindrical hole 2. The glass substrates 1 thus assembled can be rotated upon the center axis A, when they are put, for example, on a rotation table which is not shown. Each of the presser plates 5 and the fixtures 6 has a through-hole through which the slit tube 3 passes, and communicates with the cylindrical hole 2.

The slit tube 3 is a tube which has the same length as or is longer than the cylindrical hole 2 formed by the laminated glass substrates 1, and held in the cylindrical hole 2 by axial rods 10 provided on the top and bottom edges of the tube. The lower portion of the slit tube 3 is closed, and on the side portion thereof, a slit 7 to apply a coating liquid 8 to the inner surface of the cylindrical hole 2 is provided in the direction of the center axis A. The coating liquid 8 transported form a coating liquid supply apparatus (not shown) is introduced into the slit tube 3 from a coating liquid supply portion 9 and then, supplied and applied to the inner surface of the cylindrical hole 2 formed by the glass substrates 1 from the slit 7. In such a case, the upper axial rod 10 may be made to function also as a feed passage for the coating liquid so that the coating liquid is supplied into the slit tube 3 through the axis rod 10. Further, a surplus coating liquid can be discharged from an opening 4 formed at a space between the slit tube 3, and the lower presser plate 5 and fixture 6.

In order that the coating liquid is simultaneously and uniformly applied to the inner peripheral edge surfaces of the laminated glass substrates 1, the slit 7 is formed preferably longer than the height of the cylindrical hole 2 in the direction of the center axis A. However, the shape and the formation manner of the slit 7 are not limited thereto. Further, brush coating can be carried out by forming a brush at a slit portion.

In a case where the slit tube 3 is inserted into the cylindrical hole 2 formed by the laminated glass substrates 1 to apply the coating liquid 8 to the inner peripheral edge surfaces of the glass substrates, the coating is carried out preferably by rotating the glass substrates 1 upon the center axis A as shown in FIG. 1. In this Figure, the glass substrates are rotated relatively to the slit tube 3 in view of workability, but the slit tube 3 may be rotated, and as the case requires, the glass substrates 1 and the slit tube 3 may be relatively moved in an up-and-down direction. When the coating liquid is applied to the inner peripheral edge surfaces of the laminated glass substrates 1, the center axis A may be tilted at a predetermined angle to the vertical direction.

After the inner surface of the cylindrical hole 2 is coated with the coating liquid, the slit tube 3 is taken out from the cylindrical hole 2, and then the coating liquid is dried in a state where the glass substrates are laminated, and further heated and cured to form a coating film on the inner surface of the cylindrical hole 2, and then the presser plates 5 and the fixtures 6 are removed and the glass substrates 1 are separated. In such a manner, a plurality of glass substrates, each having its inner peripheral edge surface covered with a coating film, can be obtained all at once.

Now, the present invention will be described in further detail with reference to Examples. However, it should be understood that the present invention is by no means restricted to such specific Examples.

150 sheets of doughnut-type glass substrates having an inner diameter of 25 mm, an outer diameter of 84 mm and a thickness of 1 mm were prepared which were made of glass having a composition comprising, as calculated as oxides, 56 mass % of SiO₂, 6 mass % of B₂O₃, 11 mass % of Al₂O₃, 0.05 mass % of Fe₂O₃, 0.1 mass % of Na₂O, 2 mass % of MgO, 3 mass % of CaO, 15 mass % of BaO and 6.5 mass % of SrO.

The inner and outer peripheral edge surfaces of each of the above doughnut-type glass substrates were subjected to finish polishing with diamond abrasive grains smaller than #500 mesh, so that the concentricity of the outer and inner peripheries (the distance between the centers of the inner circle and the outer circle) was at most 25 μm and the roundness was at most 25 μm. Then, the front and back surfaces were subjected to lapping with alumina abrasive grains having an average particle size of 9 μm and then polished until the thickness became about 0.9 mm.

150 glass substrates thus processed were laminated and set as shown in FIG. 1 so that their circular holes at their center would form a cylindrical hole, a slit tube was inserted into the cylindrical hole and while the glass substrates were rotated upon the center axis A, a xylene solution of a silicone resin as a coating liquid was supplied to the slit tube and applied to the inner surface of the cylindrical hole from the slit.

After the coating treatment, the coating liquid applied to the inner peripheral edge surfaces of the glass substrates was dried and further heated (150° C.) for curing, to form a coating film on the inner peripheral edge surfaces of the glass substrates. Then, the laminated glass substrates were separated from the coating apparatus, and the thickness (unit:μm) of the coating film formed on each inner peripheral edge surface was measured. For measurement of the thickness, with respect to three glass substrates i.e. a third glass substrate (glass No. 1) from the top of the laminated glass substrates, a third glass substrate (glass No. 2) from the bottom and a glass substrate (glass No. 3) in the middle, the inner diameter (a) before the coating treatment and the inner diameter (b) after the coating treatment were measured by means of an inside diameter measuring apparatus manufactured by MITSUTOYO CORPORATION, and the thickness of the coating film was calculated from (a-b)/2. The inner diameter (a) was preliminarily measured before the coating treatment. The inner diameter of each glass substrate was measured on four positions, that is, on the basis of an optional position on the inner peripheral edge surface as a reference point, the inner diameter was measured at the reference point (0°), 20°, 40° and 60° in a circumferential direction of the inner peripheral edge surface. Results of the measurement are shown in Table 1.

TABLE 1

| | Measured thickness (μm) of coating film | | | | |
|---|---|---|---|---|---|
| | 0° | 20° | 40° | 60° | Average |
| Glass No. 1 | 4 | 3 | 4 | 4 | 3.8 |
| Glass No. 2 | 4 | 3 | 3 | 4 | 3.5 |
| Glass No. 3 | 4 | 5 | 3 | 4 | 4 |

As evident from Table 1, it was confirmed that the difference in film thickness among the glass substrates was small, that the difference in film thickness in the circumferential direction of the inner peripheral edge surface of each glass substrate was tolerable, and that a coating film could be substantially uniformly formed on the inner peripheral edge surface of each of the laminated glass substrates.

According to the present invention, a coating liquid can uniformly be applied to inner peripheral edge surfaces of doughnut-type glass substrates all at once to form a coating film. Accordingly, the present invention can reduce the cost, and is useful for production of glass substrates for magnetic disks.

The entire disclosure of Japanese Patent Application No. 2004-353008 filed on Dec. 6, 2004 including specification, claims, drawing and summary is incorporated herein by reference in its entirety.

What is claimed is:

1. A method for coating doughnut-type glass substrates, which comprises laminating a plurality of doughnut-type glass substrates each having a circular hole at its center so that the circular holes form a cylindrical hole, and supplying a coating liquid to an inner peripheral surface of the cylindrical hole in a state where the glass substrates are laminated to coat inner peripheral edge surfaces of the plurality of the doughnut-type glass substrates with the coating liquid.

2. The method for coating doughnut-type glass substrates according to claim 1, wherein the coating liquid is applied while rotating the doughnut-type glass substrates.

3. The method for coating doughnut-type glass substrates according to claim 1, wherein the coating liquid is applied by any one of a direct coating method of applying the coating liquid by means of a dispenser, a brush coating method or a roller coating method.

4. The method for coating doughnut-type glass substrates according to claim 2, wherein the coating liquid is applied by any one of a direct coating method of applying the coating liquid by means of a dispenser, a brush coating method or a roller coating method.
